(19) United States
(12) Patent Application Publication
(10) Pub. No.: US 2020/0034934 A1
(43) Pub. Date: Jan. 30, 2020

(54) METHODS FOR ASSESSING CONDITIONING OF A TOTAL LOSS VEHICLE AND DEVICES THEREOF

(71) Applicant: Mitchell International, Inc., San Diego, CA (US)

(72) Inventors: Philip Kroell, Oro Valley, AZ (US); Joseph Riedesel, Cardiff, CA (US)

(21) Appl. No.: 16/520,011

(22) Filed: Jul. 23, 2019

Related U.S. Application Data
(60) Provisional application No. 62/702,760, filed on Jul. 24, 2018.

(51) Int. Cl. G06Q 40/08; G06T 7/00

(52) U.S. Cl. CPC G06Q 40/08; G06T 2207/30248; G06T 7/0002

(57) ABSTRACT

A method, non-transitory computer readable medium, and apparatus that automated assessment of conditioning includes automatically analyzing one or more electronic images of a total loss property based on one or more prior condition assessments and condition guidelines rating data associated with the total loss property. A prior property conditioning of the total loss property is determined based on the analysis of the one or more obtained images. The determined prior property conditioning of the total loss property is provided.

This application claims the benefit of U.S. Provisional Patent Application Ser. No. 62/702,760, filed Jul. 24, 2018, which is hereby incorporated by reference in its entirety.

### FIELD

This technology generally relates to methods, non-transitory computer readable medium, and devices for assessing conditioning of a total loss property, such as a vehicle.

### BACKGROUND

Conditioning is a measure of wear and tear attributed to an overall state of a vehicle or other property prior to the loss. For example, if a vehicle has received routine and scheduled maintenance in accordance with manufacturer specifications, then both the exterior and interior of the vehicle will show visible signs of care that reflect a favorable conditioning. Likewise, if a vehicle has not received routine and scheduled maintenance in accordance with manufacturer specifications, then the exterior and/or interior show(s) will show visible signs of abuse that reflect a less favorable condition.

When an electronic claim is being processed for a total loss of a vehicle, the pre-loss conditioning of the vehicle is an important factor in establishing a fair market value on the total loss vehicle. Currently, existing appraisal software still requires an onsite visual vehicle damage inspection of the loss vehicle based on descriptions within condition guidelines and then manual input of one or more condition ratings that subjectively best meet the prior conditioning of the total loss vehicle. Accordingly, these prior software assessment systems are time consuming, inconsistent, and subjective resulting in errors in the establishment of the fair market value for the total loss vehicle.

### SUMMARY

A method for automated assessment of conditioning includes automatically analyzing, by a computing apparatus, one or more electronic images of a total loss property based on one or more prior condition assessments and condition guidelines rating data associated with the total loss property. A prior property conditioning of the total loss property is determined, by the computing apparatus, based on the analysis of the one or more obtained images. The determined prior property conditioning of the total loss property is provided by the computing apparatus.

A non-transitory computer readable medium having stored thereon instructions for automated assessment of conditioning comprising executable code which when executed by one or more processors, causes the one or more processors to automatically analyze one or more electronic images of a total loss property based on one or more prior condition assessments and condition guidelines rating data associated with the total loss property. A prior property conditioning of the total loss property is determined based on the analysis of the one or more obtained images. The determined prior property conditioning of the total loss property is provided.

A computing apparatus includes a memory coupled to a processor which is configured to be capable of executing programmed instructions stored in the memory to automatically analyze one or more electronic images of a total loss property based on one or more prior condition assessments and condition guidelines rating data associated with the total loss property. A prior property conditioning of the total loss property is determined based on the analysis of the one or more obtained images. The determined prior property conditioning of the total loss property is provided.

This technology provides a number of advantages including providing methods, non-transitory computer readable medium, and devices for assessing conditioning of a total loss vehicle or other property. With this technology, condition assessment artificial intelligence (AI) has been developed and trained to analyze one or more electronic images and/or videos in conjunction with pre-established condition guidelines rating data to automatically assess a prior property condition of a total loss vehicle or other property. In examples of this technology, this assessment AI is executed on the total loss vehicle as a whole based on the images without requiring disassembly of the vehicle. This technology with the assessment AI provides technological improvements resulting in increases in accuracy and consistency when evaluating a prior conditioning of the vehicle or other property. Further, with these improvements in the automated evaluation process there is an increase in settlement efficiency of electronic insurance claims relating to a total loss vehicle or other property by eliminating the need for a subjective onsite inspection of the vehicle or other property.

### BRIEF DESCRIPTION OF THE DRAWINGS

FIG. 1 is a block diagram of an environment with an example of a condition management computing apparatus that assesses prior property conditioning of a total loss property;

FIG. 2 is a block diagram of the example of the condition management computing apparatus shown in FIG. 1;

FIG. 3 is a flow chart of an example of a method for assessment of prior property conditioning of the total loss property;

FIG. 4 is a diagram of an example of identified parts of an interior of a total loss vehicle to be assessed for prior conditioning;

FIG. 5 is a diagram of an example of identified parts of an exterior of the total loss vehicle to be assessed for prior conditioning;

FIG. 6 is a diagram of an example of identified parts of mechanical elements of the total loss vehicle to be assessed for prior conditioning;

FIG. 7 is an image of an example of a tire of the total loss vehicle to be assessed for prior conditioning;

FIG. 8 are images of an example of a parts of an interior and an exterior of the total loss vehicle; and

FIG. 9 is table of an example of an assessment of prior part conditioning of parts of a vehicle with exemplary individual and overall assessment ratings.

### DETAILED DESCRIPTION

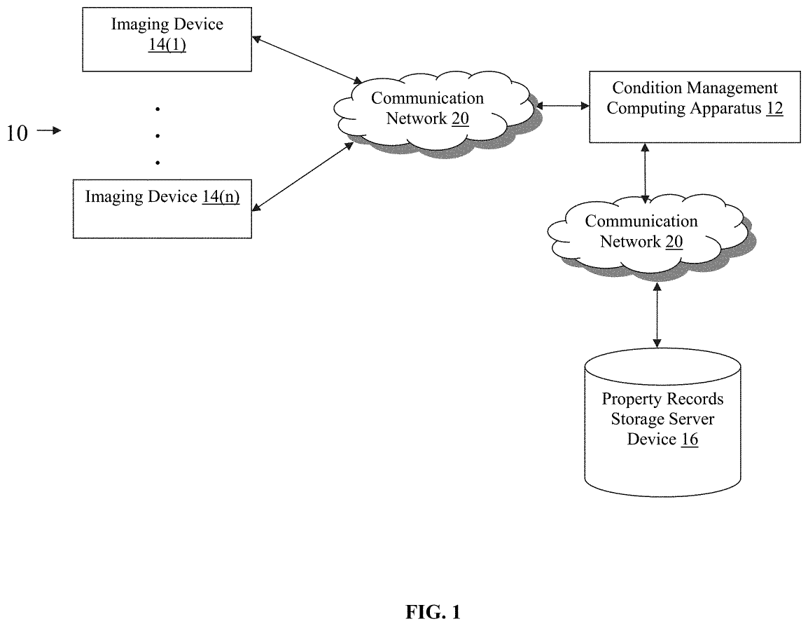

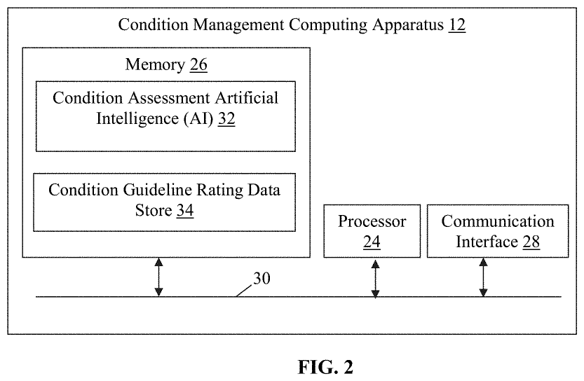

An environment 10 with an example of a condition management computing apparatus 12 is illustrated in FIGS. 1-2. In this particular example, the environment 10 includes the condition management computing apparatus 12, imaging devices 14(1)-14(n), and a property records storage server device 16 coupled via one or more communication networks 18, although the environment could include other types and numbers of systems, devices, components, and/or other elements as is generally known in the art and will not be illustrated or described herein. This technology provides a number of advantages including providing methods, non-transitory computer readable medium, and apparatuses for more accurately and effectively assessing prior property conditioning of a total loss vehicle or other property.

Referring more specifically to FIGS. 1-2, the condition management computing apparatus 12 is programmed to assess prior property conditioning of a total loss vehicle or other property as illustrated and described herein, although the apparatus can perform other types and/or numbers of functions or other operations and this technology can be utilized with other types of claims. In this particular example, the condition management computing apparatus 12 includes a processor 24, a memory 26, and a communication interface 28 which are coupled together by a bus 30, although the condition management computing apparatus 12 may include other types and/or numbers of physical and/or virtual systems, devices, components, and/or other elements in other configurations.

The processor 24 in the condition management computing apparatus 12 may execute one or more programmed instructions stored in the memory 26 for assessing prior property conditioning of a total loss vehicle or other property as illustrated and described in the examples herein, although other types and numbers of functions and/or other operation can be performed. The processor 24 in the condition management computing apparatus 12 may include one or more central processing units and/or general purpose processors with one or more processing cores, for example.

The memory 26 in the condition management computing apparatus 12 stores the programmed instructions and/or other data for one or more aspects of the present technology as described and illustrated herein, although some or all of the programmed instructions and/or data could be stored and/or executed or obtained elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 24, can be used for the memory 26. In this particular example, the memory 26 includes condition assessment Artificial Intelligence (AI) 32 and a condition guideline rating data store 34, although the memory 26 can comprise other types and/or numbers of other modules, programmed instructions and/or data. Examples of the programmed instructions and/or data in the condition assessment Artificial Intelligence (AI) 32 and the condition guideline rating data store 34 are illustrated and described by way of the examples herein.

The communication interface 28 in the condition management computing apparatus 12 operatively couples and communicates between one or more of the imaging devices 14(1)-14(n) and the property records storage server device 16, which are all coupled together by one or more of the communication networks 18, although other types and numbers of communication networks or systems with other types and numbers of connections and configurations to other devices and elements. By way of example only, the communication networks 18 can use TCP/IP over Ethernet and industry-standard protocols, including NFS, CIFS, SOAP, XML, LDAP, SCSI, and SNMP, although other types and numbers of communication networks, can be used. The communication networks 18 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the imaging devices 14(1)-14(n) may capture and provide images, such as picture and/or videos by way of example only, of parts and/or all of an interior, exterior, mechanical elements, and/or other categories of the total loss vehicle or other property for an assessment of prior property conditioning by the condition management computing apparatus 12, although the images can be obtained by the condition management computing apparatus 12 in other manners and/or from other sources.

The property records storage server device 16 may store and provide requested information and/or other content about the total loss vehicle or other property, such as which part or parts and/or categories need to be examined for assessing prior property conditioning as well as other information, such as vehicle information and/or owner data and identification by way of example only. The condition management computing apparatus 12 may interact with the property records storage server device 16 via one or more of the communication networks 18, for example, although other types and/or numbers of storage media in other configurations with other stored information could be used. The property records storage server device 16 also may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the property records storage server device 16 and may transmit data in response to requests from the condition management computing apparatus 12.

Each of the imaging devices 14(1)-14(n) and the property records storage server device 16 may include a processor, a memory, and a communication interface, which are coupled together by a bus or other link, although other type and/or numbers of other devices and/or nodes as well as other network elements could be used.

Although the exemplary network environment 10 with the condition management computing apparatus 12, the imaging devices 14(1)-14(n), the property records storage server device 16, and the communication networks 18 are described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

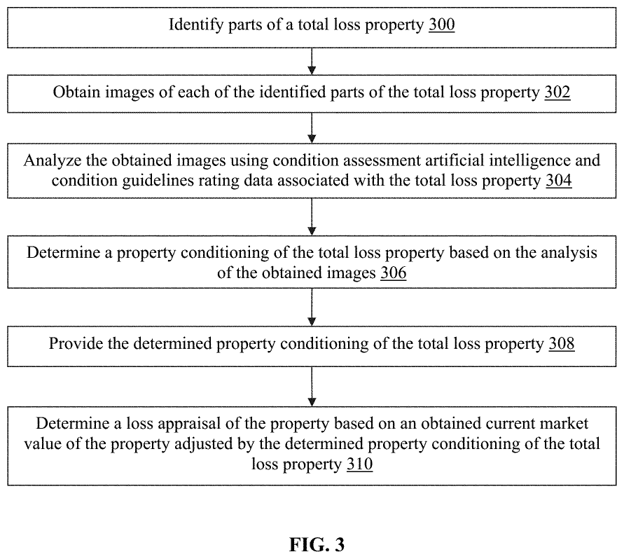

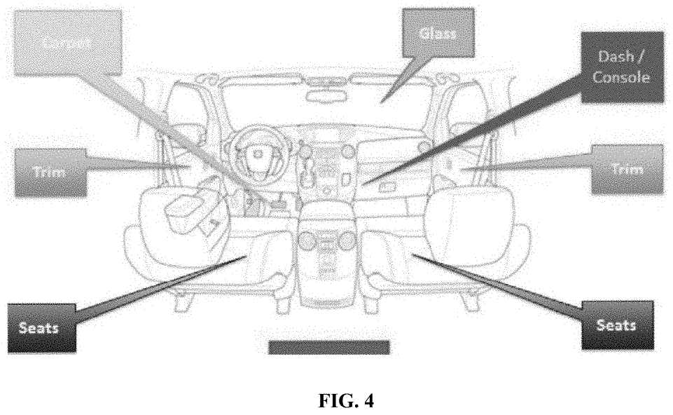

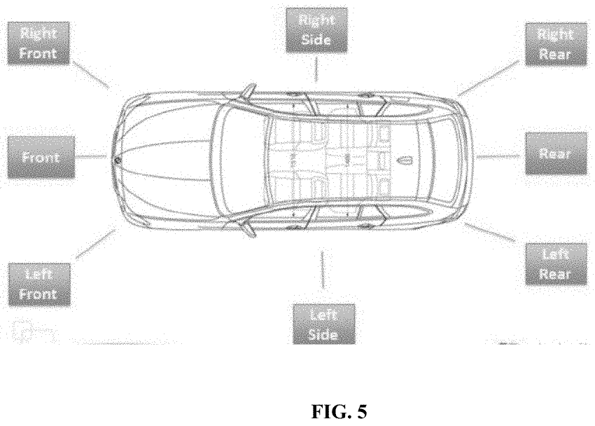

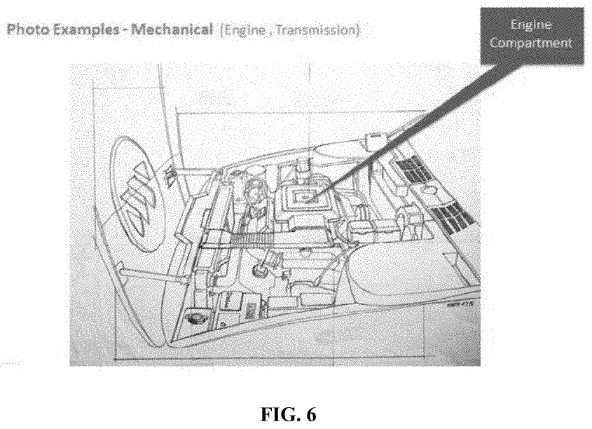

An example of a method of assessing prior property conditioning of a total loss vehicle or other property will now be described with reference to FIGS. 1-9. Referring more specifically to FIG. 3, in step 300 the condition management computing apparatus 12 may interact with the property records storage server 16 to identify the total loss vehicle or other property and the one or more parts that need to be assessed for conditioning, although the identity of the total loss vehicle or other property and/or of the one or more parts that need to be assessed can be obtained in other manners. By way of example only, the identified parts to assess for conditioning of the total loss vehicle or other property may be determined by the condition management computing apparatus 12 based on interactions with the property records storage server 16 to comprise categories of interior, exterior, operational mechanical elements, and tires, although other types and/or numbers of categories may be used. In this example, the interior category of the total loss vehicle may include the carpet, glass, dash/console, trim, and seats as shown in FIG. 4, the exterior category of the total loss vehicle may include the right front, right side, right rear, rear, left rear, left side, left front, and front of the total loss vehicle as shown in FIG. 5, the operational mechanical elements category of the total loss vehicle may include the engine compartment as shown in FIG. 6, a braking system, and a steering system, and the tire category of the total loss vehicle may include each of tires of the total loss vehicle, although other types and/or numbers of categories and elements in each category may be used.

The condition management computing apparatus 12 may also optionally receive or otherwise obtain other data or information relating to the property to be assessed for property conditioning and/or for appraisal of the total loss, such as owner data and other claim processing related data. This example of the technology is able to more accurately and consistently identify the particular one or more categories and the one or more parts in each total loss vehicle or other property to assess for conditioning. Additionally, this example of the technology allows for the easy adjustment of and then ongoing consistent application of the particular categories and/or parts which previously was not available.

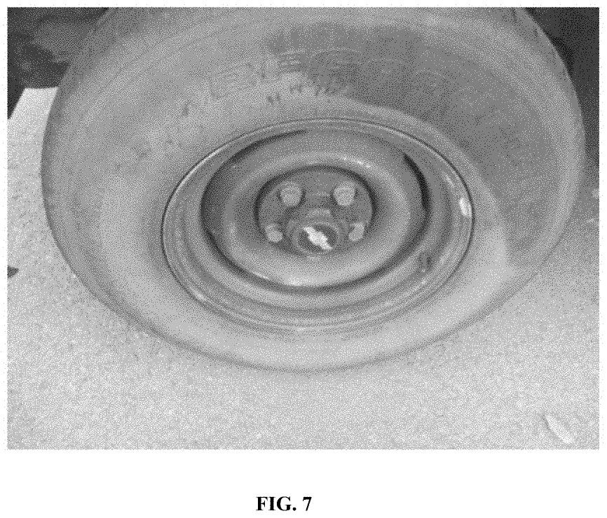

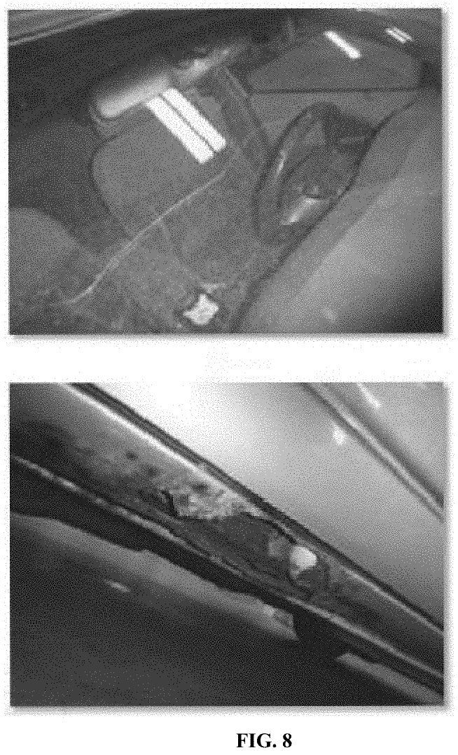

In step 302, the condition management computing apparatus 12 may obtain one or more electronic images of each of the identified one or more parts of the total loss vehicle or other property. By way of example only, one or more of the imaging devices 14(1)-14(n) may be used to capture images, such as pictures and/or videos, of the identified parts in each of the categories for the assessment of the part conditioning that is used to obtain the property conditioning of each of the categories and of the total loss vehicle or other property. In the examples discussed herein, electronic image refers to an image or video in a format compatible for automated analysis. By way of example only, an electronic image of one tire is shown in FIG. 7 and two images of parts of an interior and an exterior of a total loss vehicle are shown in FIG. 8.

This example of the technology is able to ensure that the necessary images for assessment of conditioning of each of the parts in each of the categories is obtained to ensure a more accurate and consistent automated property conditioning assessment. If any necessary images for any of the categories is missing, the condition management computing apparatus 12 may identify and obtain the other one or more missing electronic images, such as by determining based on a stored table for the associated type of loss property on what images are need and then transmitting an electronic request for any missing image or images. Although in this example, the images are obtained from one or more of the imaging devices 14(1)-14(n), the images can be obtained by the condition management computing apparatus 12 from other sources, such as from prior stored images of the total loss vehicle or other property, e.g. a recent inspection of the total loss vehicle or other property.

In step 304, the condition management computing apparatus 12 may analyze the one or more electronic images for each of the one or more parts using the condition assessment artificial intelligence (AI) 32 and the condition guidelines rating data 34 to obtain an assessment of part conditioning comprising a rating for each of the one or more parts of the total loss vehicle, such as parts of the internal and external sections of the vehicle by way of example only. The condition assessment artificial intelligence (AI) 32 is a technological improvement over prior software assessment technologies and enables accurate and efficient condition assessments of the parts of the total loss vehicle or other property without requiring any disassembly. The condition assessment artificial intelligence (AI) 32 may utilize by way of example deep learning through an analysis of prior images and condition assessments of a total loss vehicle of other property to generate stored conditioning data and a conditioning assessment algorithm or other executable rule or rules which can be used for new conditioning assessments. Additionally, the condition assessment artificial intelligence (AI) 32 may also continue to learn and update based on each new assessment and any received feedback to further refine the a conditioning assessment algorithm or other executable rule or rules. Further, the condition assessment artificial intelligence (AI) 32 may be trained to identify and distinguish between routine or expected wear and/or surface grime and actual damage or deterioration of for each type of a plurality of vehicles or other property to further refine the a conditioning assessment algorithm or other executable rule or rules. Even further, the condition assessment artificial intelligence (AI) 32 may be trained to provide an assessment of parts which are not visible without requiring disassembly of the vehicle or other item being analyzed based on the obtained images and data on the vehicle or other item being assessed to further refine the a conditioning assessment algorithm or other executable rule or rules.

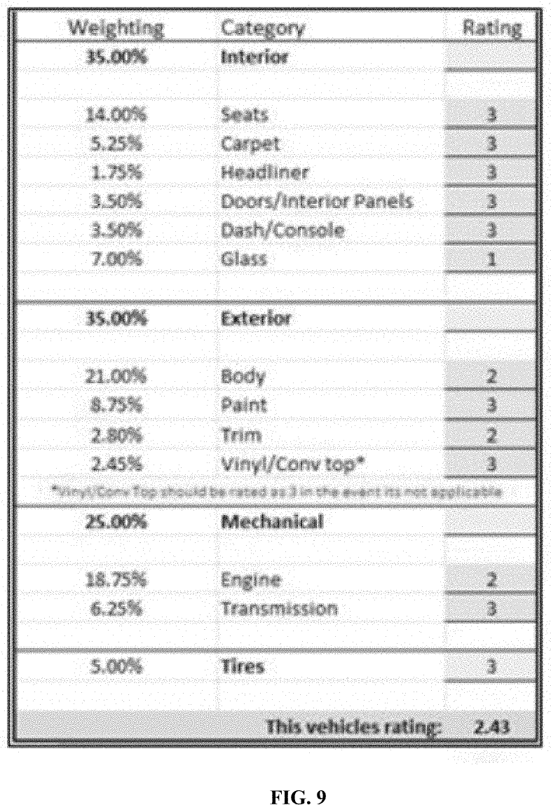

By way of example only, the condition guidelines rating data 34 for each of a plurality of types of vehicles or other property may comprise information to set condition ratings for each of the parts in each of the categories. The condition management computing apparatus 12 may identify for example based on an identification of the total loss vehicle or other property the appropriate condition guidelines rating data for the particular total loss vehicle or other property being assessed for conditioning, although other manners for identifying one of the guidelines rating data may be used, such as from an analysis of electronic images by way of example. By way of example only, automated ratings obtained for each of the parts in each of the categories in step 304 is illustrated in FIG. 9.

In step 306, the condition management computing apparatus 12 may determine a prior property conditioning of the total loss property based on the automated analysis of the one or more obtained electronic images. In this example, the condition management computing apparatus 12 may also obtain a part weighting factor for each of the one or more parts in each of the categories of the total loss vehicle or other property. A weighting factor may be assigned to each of the parts in each of the categories by the condition management computing apparatus 12 as shown by way of example in FIG. 9. By way of example, the weighting factors which may be utilized by the condition management computing apparatus 12 may vary based on the particular type of vehicle or other property and may be based on one or more of these considerations: (1) Importance/Rank—This refers to the significance the subcategory has to the overall condition of the vehicle, meaning from a consumers perspective; (2) Occurrence Rate—This refers to the frequency that the subcategory component(s) is subjected to Wear/Tear/Damage. (3) Value—This refers to the value or cost that the subcategory component(s) has on the overall vehicles value compared to other subcategory component(s).

The condition management computing apparatus 12 may determine a prior part conditioning assessment for each part in each category based on the analysis in step 304 and then may apply the weighting factor based on the particular type of vehicle or other property to each of the ratings for each of the parts. Accordingly, a weighted condition assessment rating for the prior property conditioning for each of the parts, the categories, and/or the overall vehicle or other property may be obtained as shown in FIG. 9.

In step 308, the condition management computing apparatus 12 may provide the determined rating for the prior property conditioning of the total loss property, such as for an electronic claim for the total loss vehicle or other property that is being processed, although the assessment can be provide for other purposes.

In step 310, the condition management computing apparatus may determine a loss appraisal of the property based on an obtained current market value of the property obtained from another source and then adjusted by subtracting the determined prior property conditioning of the total loss property or making some other programmed adjustment.

Accordingly, as illustrated and described by way of the examples herein, this technology provides more accurate and effective assessment of prior conditioning of a total loss vehicle or other property which is not routine or conventional in this technology area. With this technology, condition assessment artificial intelligence (AI) may be used to automatically analyze one or more electronic images and/or videos in conjunction with pre-established condition guidelines rating data to automatically assess a prior property condition of a total loss vehicle or other property. This technology with the assessment AI provides technological improvements resulting in increases in accuracy and consistency when evaluating a prior conditioning of the vehicle or other property. Further, with these improvements in the automated evaluation process there is an increase in settlement efficiency of electronic insurance claims relating to a total loss vehicle or other property by eliminating the need for an onsite inspection of the vehicle or other property.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
automatically analyzing, by the computing apparatus, one or more electronic images of a total loss property based on one or more prior condition assessments and condition guidelines rating data associated with the total loss property;
determining, by the computing apparatus, a prior property conditioning of the total loss property based on the analysis of the one or more obtained images; and
providing, by the computing apparatus, the determined prior property conditioning of the total loss property.

2. The method as set forth in claim 1 wherein the analyzing the one or more electronic images further comprises analyzing, by the computing apparatus, the one or more images with condition assessment artificial intelligence based on stored conditioning data encoded from one or more prior condition assessments and the condition guidelines rating data.

3. The method as set forth in claim 2 further comprising:
identifying, by the condition management computing apparatus, one or more parts of the total loss property based on an identification of the total loss property;
wherein the one or more electronic images further comprise one or more electronic images of each of the identified one or more parts of the total loss property.

4. The method as set forth in claim 3 wherein the analyzing the one or more electronic images and the determining the prior property conditioning of the total loss property further comprises:
analyzing, by the computing apparatus, the one or more electronic images for each of the one or more parts using the condition assessment artificial intelligence and the condition guidelines rating data for each of the one or more parts of the total loss property; and
determining, by the computing apparatus, a prior part conditioning for each of the one or more parts of the total loss property based on the analysis of the one or more electronic images for each of the one or more parts of the total loss property and the prior property conditioning of the total loss property based on the prior part conditioning for each of the one or more parts of the total loss property.

5. The method as set forth in claim 4 further comprising:
obtaining, by the computing apparatus, a part weighting factor for each of the one or more parts of the property;
wherein the determining the prior property conditioning of the total loss property based on the prior part conditioning for each of the one or more parts of the total loss property is further based on applying the part weighting factor for each of the one or more parts of the property on the prior part conditioning for each of the one or more parts of the total loss property.

6. The method as set forth in claim 5 further comprising:
obtaining, by the computing apparatus, two or more categories of the one or more parts of the property, each of the two or more categories having a category weighting factor, wherein the part weighting factor for each of the one or more parts of the property in each category is based on the category weighting factor.

7. The method as set forth in claim 1 further comprising determining, by the computing apparatus, a loss appraisal of the property based on an obtained current market value of the property adjusted by the determined prior property conditioning of the total loss property.

8. A non-transitory computer readable medium having stored thereon instructions for automated assessment of conditioning comprising executable code which when executed by one or more processors, causes the one or more processors to:
automatically analyze one or more electronic images of a total loss property based on one or more prior condition assessments and condition guidelines rating data associated with the total loss property;
determine a prior property conditioning of the total loss property based on the analysis of the one or more obtained images; and
provide the determined prior property conditioning of the total loss property.

9. The medium as set forth in claim 8 wherein for the analyze the one or more electronic images, the executable code when executed by the one or more processors further causes the one or more processors to:
analyze the one or more images with condition assessment artificial intelligence based on stored conditioning data encoded from one or more prior condition assessments and the condition guidelines rating data.

10. The medium as set forth in claim 9 wherein the executable code when executed by the one or more processors further causes the one or more processors to:
identify one or more parts of the total loss property based on an identification of the total loss property;
wherein the one or more electronic images further comprises one or more electronic images of each of the identified one or more parts of the total loss property.

11. The medium as set forth in claim 10 wherein the executable code when executed by the one or more processors for the analyze the one or more electronic images and the determine the prior property conditioning of the total loss property further causes the one or more processors to:
analyze the one or more electronic images for each of the one or more parts using the condition assessment artificial intelligence and the condition guidelines rating data for each of the one or more parts of the total loss property; and
determine a prior part conditioning for each of the one or more parts of the total loss property based on the analysis of the one or more electronic images for each of the one or more parts of the total loss property and the prior property conditioning of the total loss property based on the prior part conditioning for each of the one or more parts of the total loss property.

12. The medium as set forth in claim 11 wherein the executable code when executed by the one or more processors further causes the one or more processors to:
obtain a part weighting factor for each of the one or of the parts of the property;
wherein the determine the prior property conditioning of the total loss property based on the prior part conditioning for each of the one or more parts of the total loss property is further based on applying the part weighting factor for each of the one or more parts of the property on the prior part conditioning for each of the one or more parts of the total loss property.

13. The medium as set forth in claim 12 wherein the executable code when executed by the one or more processors further causes the one or more processors to:
obtain two or more categories of the one or more parts of the property, each of the two or more categories having a category weighting factor, wherein the part weighting factor for each of the one or more parts of the property in each category is based on the category weighting factor.

14. The medium as set forth in claim 8 wherein the executable code when executed by the one or more processors further causes the one or more processors to:
determine a loss appraisal of the property based on an obtained current market value of the property adjusted by the determined prior property conditioning of the total loss property.

15. A computing apparatus comprising:
a processor; and
a memory coupled to the processor which is configured to be capable of executing programmed instructions stored in the memory to:
automatically analyze one or more electronic images of a total loss property based on one or more prior condition assessments and condition guidelines rating data associated with the total loss property;
determine a prior property conditioning of the total loss property based on the analysis of the one or more obtained images; and
provide the determined prior property conditioning of the total loss property.

16. The apparatus as set forth in claim 15 wherein for the analyze the one or more electronic images, the processor coupled to the memory is further configured to be capable of executing at least one additional programmed instruction stored in the memory to:
analyze the one or more images with condition assessment artificial intelligence based on stored conditioning data encoded from one or more prior condition assessments and the condition guidelines rating data.

17. The apparatus as set forth in claim 16 wherein the processor coupled to the memory is further configured to be capable of executing at least on additional programmed instruction stored in the memory to:
identify one or more parts of the total loss property based on an identification of the total loss property;
wherein the one or more electronic images further comprises one or more electronic images of each of the identified one or more parts of the total loss property.

18. The apparatus as set forth in claim 17 wherein the processor coupled to the memory is further configured for the analyze the one or more electronic images and the determine the prior property conditioning of the total loss property to be capable of executing at least one additional programmed instruction stored in the memory to:
analyze the one or more electronic images for each of the one or more parts using the condition assessment artificial intelligence and the condition guidelines rating data for each of the one or more parts of the total loss property; and
determine a prior part conditioning for each of the one or more parts of the total loss property based on the analysis of the one or more electronic images for each of the one or more parts of the total loss property and the prior property conditioning of the total loss property based on the prior part conditioning for each of the one or more parts of the total loss property.

19. The apparatus as set forth in claim 18 wherein the processor coupled to the memory is further configured to be capable of executing at least one additional programmed instruction stored in the memory to:
obtain a part weighting factor for each of the one or more parts of the property; wherein the determine the prior property conditioning of the total loss property based on the prior part conditioning for each of the one or more parts of the total loss property is further based on applying the part weighting factor for each of the one or more parts of the property on the prior part conditioning for each of the one or more parts of the total loss property.

20. The apparatus as set forth in claim 19 wherein the processor coupled to the memory is further configured to be capable of executing at least one additional programmed instruction stored in the memory to:
obtain two or more categories of the one or more parts of the property, each of the two or more categories having a category weighting factor, wherein the part weighting factor for each of the one or more parts of the property in each category is based on the category weighting factor.

21. The apparatus as set forth in claim 15 wherein the processor coupled to the memory is further configured to be capable of executing at least one additional programmed instruction stored in the memory to:
determine a loss appraisal of the property based on an obtained current market value of the property adjusted by the determined prior property conditioning of the total loss property.
